(19) United States
(12) Patent Application Publication
(10) Pub. No.: US 2019/0303946 A1
(43) Pub. Date: Oct. 3, 2019

(54) INFORMATION PROCESSING SYSTEM, AND CUSTOMER IDENTIFICATION APPARATUS

(71) Applicant: NEC Corporation, Tokyo (JP)

(72) Inventor: Shintaro YAMADA, Tokyo (JP)

(73) Assignee: NEC Corporation, Tokyo (JP)

(21) Appl. No.: 16/468,152

(22) PCT Filed: Sep. 5, 2017
(86) PCT No.: PCT/JP2017/031891

§ 371 Date: Jun. 10, 2019

(30) Foreign Application Priority Data
Dec. 20, 2016 (JP) 2016-246537

(51) Int. Cl. G06Q 20/40; G07G 1/00; G06K 9/00

(52) U.S. Cl. CPC G06Q 20/40145; G06K 9/00288; G06K 9/00255; G07G 1/0036

(57) ABSTRACT

According to the present invention, there is provided an information processing system including an acquisition unit (11) that acquires an image, which is generated by a first camera, of a face; an identification unit (12) that identifies a first customer who pays based on the acquired image and database information in which a feature value of a face is registered; and a settlement unit (checkout unit (21)) that performs a settlement process with respect to the identified first customer. The identification unit (12) identifies the first customer before an operation of starting the settlement process is performed.

### TECHNICAL FIELD

The present invention relates to an information processing system, a customer identification apparatus, an information processing method, and a program.

### BACKGROUND ART

Patent Document 1 discloses an information processing system using a face authentication process for a settlement operation. Patent Document 1 discloses that the information processing system acquires information which includes face information of a visitor, and performs face authentication using the face information, which is included in the acquired information, of the visitor and registered face information, which has been registered in a member database, of each member.

### RELATED DOCUMENT

### Patent Document

[Patent Document 1] Japanese Unexamined Patent Publication No. 2016-126749

### SUMMARY OF THE INVENTION

### Technical Problem

In a face authentication process, the more information which is registered the more time is taken for the authentication process. As a result, waiting time for the face authentication process may be generated while settlement is being performed. An object of the present invention is to suppress the waiting time for the face authentication process while the settlement is being performed using the face authentication process.

### Solution to Problem

According to the present invention, there is provided an information processing system including:
an acquisition unit that acquires an image, which is generated by a first camera, of a face;
an identification unit that identifies a first customer who pays, based on the acquired image and database information in which a feature value of a face is registered; and
a settlement unit that performs a settlement process with respect to the identified first customer, in which the identification unit identifies the first customer before an operation of starting the settlement process is performed.

In addition, according to the present invention, there is provided an information processing system including:
an acquisition unit that acquires an image, which is generated by a first camera, of a face;
an identification unit that identifies a first customer who pays, based on the acquired image and database information in which a feature value of a face is registered; and
a settlement unit that performs a settlement process with respect to the identified first customer,
in which the identification unit identifies the first customer in a case where a process of registering a product purchased by the first customer starts.

In addition, according to the present invention, there is provided a customer identification apparatus including:
an acquisition unit that acquires an image, which is generated by a first camera, of a face;
an identification unit that identifies a first customer who pays, based on the acquired image and database information in which a feature value of a face is registered; and
a notification unit that notifies information for identifying the identified customer corresponding to the customer to a checkout apparatus,
in which the identification unit identifies the first customer before an operation of starting the settlement process is performed.

In addition, according to the present invention, there is provided an information processing method, which is executed by a computer, the method including:
an acquisition step of acquiring an image, which is generated by a first camera, of a face;
an identification step of identifying a first customer who pays, based on the acquired image and database information in which a feature value of a face is registered; and
a settlement step of performing a settlement process with respect to the identified first customer,
in which, in the identification step, the first customer is identified before an operation of starting the settlement process is performed.

In addition, according to the present invention, there is provided a program causing a computer to function as:
an acquisition unit that acquires an image, which is generated by a first camera, of a face;
an identification unit that identifies a first customer who pays, based on the acquired image and database information in which a feature value of a face is registered; and
a settlement unit that performs a settlement process with respect to the identified first customer,
in which the identification unit identifies the first customer before an operation of starting the settlement process is performed.

### Advantageous Effects of Invention

According to the present invention, it is possible to suppress the waiting time for the face authentication process while settlement is being performed using the face authentication process.

### BRIEF DESCRIPTION OF THE DRAWINGS

The above-described object, other objects, features, and advantages will be further apparent with preferable example embodiments, which will be described below, and the accompanying drawings below.

FIG. 1 is an example of a functional block diagram illustrating an information processing system of the present example embodiment.

FIG. 2 is a diagram conceptually illustrating an example of a hardware configuration of a system and an apparatus of the present example embodiment.

FIG. 3 is an example of a functional block diagram illustrating a customer identification apparatus of the present example embodiment.

FIG. 4 is a diagram schematically illustrating an example of database information of the present example embodiment.

FIG. 5 is a diagram schematically illustrating an example of information generated by the customer identification apparatus of the present example embodiment.

FIG. 6 is a flowchart illustrating an example of a flow of a process of the customer identification apparatus of the present example embodiment.

FIG. 7 is a flowchart illustrating an example of a flow of the process of the customer identification apparatus of the present example embodiment.

FIG. 8 is a diagram illustrating a realization example of the information processing system of the present example embodiment.

FIG. 9 is a diagram illustrating the realization example of the information processing system of the present example embodiment.

FIG. 10 is a diagram illustrating an example of a settlement operation.

FIG. 11 is a diagram illustrating a process of the customer identification apparatus of the present example embodiment.

FIG. 12 is an example of screen display by the information processing system of the present example embodiment.

FIG. 13 is an example of the screen display by the information processing system of the present example embodiment.

FIG. 14 is an example of a functional block diagram illustrating the information processing system of the present example embodiment.

FIG. 15 is an example of a functional block diagram illustrating the information processing system of the present example embodiment.

FIG. 16 is an example of a functional block diagram illustrating a checkout apparatus of the present example embodiment.

FIG. 17 is a sequence diagram illustrating an example of a flow of a process of the information processing system of the present example embodiment.

FIG. 18 is a diagram schematically illustrating an example of database information of the present example embodiment.

### DESCRIPTION OF EMBODIMENTS

### First Example Embodiment

First, an outline of an information processing system of the present example embodiment will be described. The information processing system of the present example embodiment is an apparatus which performs a process (registration process) of registering a product to be checked out, a settlement process, and the like. The information processing system of the present example embodiment is, for example, a Point Of Sales (POS) register. It may be assumed that the POS register is operated by a sales clerk or may be operated by a customer.

It is possible for the information processing system of the present example embodiment to perform the settlement process using a face authentication process. The face authentication process is a process of identifying the customer using an image of the face of the customer. That is, the information processing system identifies a customer (first customer) who pays, using an image acquired by capturing the customer and a database in which a feature value of an appearance of a customer is registered. Furthermore, the information processing system performs the settlement process using electronic money information or point information, which corresponds to the identified customer.

It should be noted that, the information processing system starts a process of identifying the customer using the image (hereinafter, the same as an authentication process in the description below) from a prescribed timing before an operation of starting the settlement process is performed. Therefore, it is expected to complete identifying the customer before the operation of starting the settlement process is performed. As a result, it is possible to suppress waiting time for the face authentication process while settlement is being performed using the face authentication process.

Subsequently, a configuration of the information processing system will be described. First, a hardware configuration of the information processing system will be described. Each functional unit included in the information processing system of the present example embodiment is realized by any combination of hardware and software of any computer based on a Central Processing Unit (CPU), a memory, a program which is loaded on the memory, a storage unit (which is capable of storing a program which is downloaded from a storage medium, such as a Compact Disc (CD), a server on the Internet, or the like, in addition to a program that is previously stored from a stage in which an apparatus is delivered), such as a hard disk, which stores the program, and an interface for network connection. Furthermore, those skilled in the art understand that various modification examples exist for a realization method and an apparatus thereof.

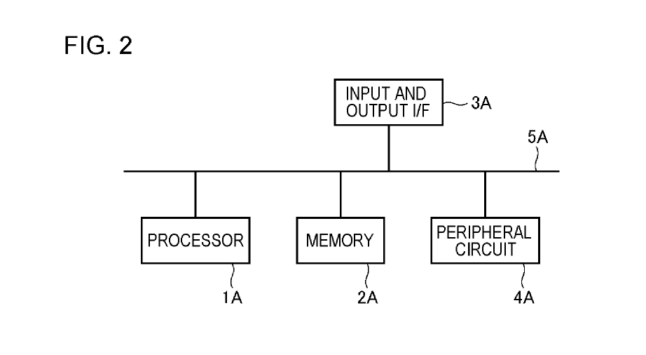

FIG. 2 is a block diagram illustrating the hardware configuration of the information processing system of the present example embodiment. As illustrated in FIG. 2, the information processing system includes a processor 1A, a memory 2A, an input and output interface 3A, a peripheral circuit 4A, and a bus 5A. The peripheral circuit 4A includes various modules.

The bus 5A is a data transmission path which is used for the processor 1A, the memory 2A, the peripheral circuit 4A, and the input and output interface 3A to transmit and receive data to and from each other. The processor 1A is, for example, an arithmetic processing apparatus such as the Central Processing Unit (CPU) or a Graphics Processing Unit (GPU). The memory 2A is, for example, a memory such as a Random Access Memory (RAM) or a Read Only Memory (ROM). The input and output interface 3A includes an interface which is used to acquire information from an input apparatus (for example: a keyboard, a mouse, a microphone, a physical key, a touch panel display, a code reader, or the like), an external apparatus, an external server, an external sensor, and the like, and an interface which is used to output information to an output apparatus (for example: a display, a speaker, a printer, an emailer, or the like), the external apparatus, the external server, and the like. It is possible for the processor 1A to output an instruction to each of the modules and to perform an arithmetic operation based on an arithmetic result of each of the modules.

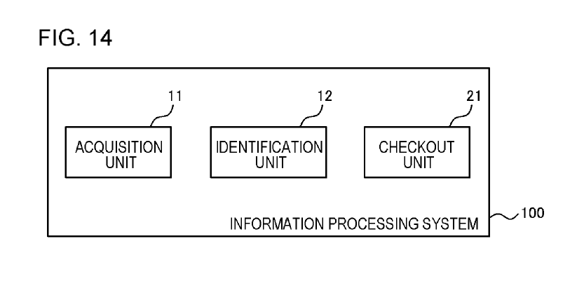

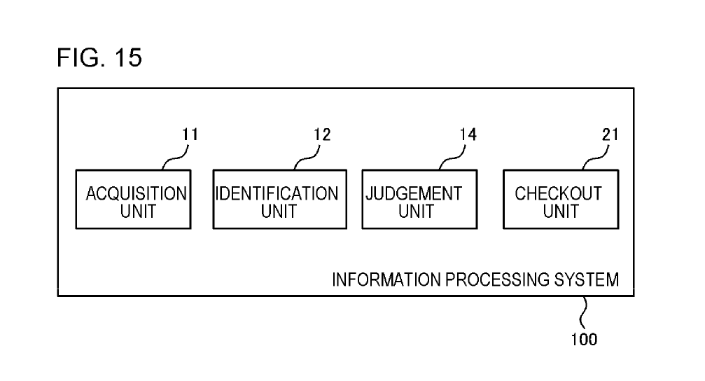

Subsequently, a functional configuration of the information processing system will be described. FIG. 14 illustrates an example of a functional block diagram of the information processing system 100. As illustrated in the drawing, the information processing system 100 includes an acquisition unit 11, an identification unit 12, and a checkout unit 21. As illustrated in FIG. 15, the information processing system may further include a judgement unit 14. In addition, although not illustrated in the drawing, the information processing system 100 may further include a display control unit.

The checkout unit 21 includes a unit (registration unit) that performs a process (the registration process) of registering a product to be checked out, and a unit (a settlement unit) that performs a settlement process.

First, the registration process, which is performed by the checkout unit 21, will be described. The checkout unit 21 includes a unit that is used to input information for identifying the product to be checked out. The input is realized by various apparatuses such as the code reader, the physical key, the touch panel display, the microphone, and the camera.

For example, the information for identifying the product may be input in such a way that the code reader reads a code which is attached to the product and which indicates information for identifying the product. In addition, the information for identifying the product may be input through operation of the physical key or the touch panel display. In addition, the information for identifying the product may be input by voice through the microphone. In addition, the information for identifying the product may be input using the camera that captures the product to be checked out and a unit that identifies a product included in an image which is generated by the camera based on a feature value of an appearance of the product or a code (the information for identifying the product which is attached to the product) included in the mage.

It is possible for the checkout unit 21 to acquire product information (for example, price or the like) corresponding to the information for identifying the product to be checked out from a previously prepared product master. Furthermore, it is possible for the checkout unit 21 to perform a checkout process of computing the sum of prices of one or more products to be checked out. Furthermore, it is possible for the checkout unit 21 to display the information for identifying the product to be checked out, the computed sum, and the like on the display or the like. Here, it is possible for the information processing system to include the display control unit that controls display on a display unit such as the display.

Subsequently, a settlement process performed by the checkout unit 21 will be described. The settlement process refers to completing a sales transaction in which the amount of money to be paid is decided, by a selected payment method (cash, a credit card, points, or the like). It is possible for the checkout unit 21 to perform the settlement process using electronic money information or point information, which corresponds to the customer identified through a face authentication process. That is, in a case where information for identifying the customer identified by the identification unit 12, which will be described below, is acquired, it is possible for the checkout unit 21 to acquire the electronic money information or the point information, which corresponds to the customer, from the server. Furthermore, it is possible for the checkout unit 21 to perform the settlement process using the electronic money information or the point information. That is, the settlement process of paying the sum of the prices of the products to be checked out using the electronic money or the points or a settlement process of adding points, which are given in present shopping, to remaining points indicated by the point information may be performed. In addition, in a case of the information processing system 100 in a store installed in an inside of an organization such as a company, a settlement process may be performed by accumulating the amount of money to be paid in association with information (for example: employee number) for identifying the customer within the organization, and deducting the amount of money to be paid from salaries.

It should be noted that, it may be possible for the checkout unit 21 to perform the settlement process using the cash, the credit card, another type of electronic money, another type of point, and the like. For example, in a case where the customer is not identified by the identification unit 12, the settlement process may be performed using another method which is illustrated.

The checkout unit 21 performs the registration process and the settlement process in this order. In a case where an operation is performed to start the settlement process after the registration process of registering at least one product, the checkout unit 21 starts the settlement process according to the operation.

The operation performed to start the settlement process may be, for example, pressing of the physical key corresponding to “start of the settlement process”. In addition, the operation may be, for example, an operation (for example: touch) to be performed on an area corresponding to the “start of the settlement process” over a touch panel area. In addition, the operation may be, for example, an input of a prescribed word corresponding to the “start of the settlement process” through the microphone. Note that, the examples here are only examples, and the present invention is not limited thereto.

The acquisition unit 11 acquires the image which includes a face of the customer and which is generated by the camera (first camera) which images the customer. The first camera is installed to capture the face of the customer who is located in a vicinity of the information processing system 100, more specifically, the face of the customer who is performing the settlement. The first camera may capture a moving image in succession or may capture a still image at a prescribed timing. That is, the acquisition unit 11 may acquire images corresponding to a plurality of frames which are generated in succession at prescribed time intervals from the first camera, or may acquire one image, which is generated at certain timing, from the first camera. That is, it is possible for the acquisition unit 11 to acquire the plurality of images imaged at different timings.

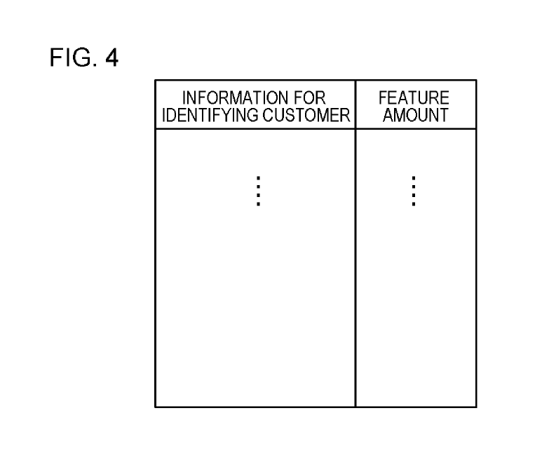

It is possible for the identification unit 12 to identify the customer based on database information (refer to FIG. 4), in which feature values of faces of a plurality of persons are registered, and the image which is acquired by the acquisition unit 11. For example, the identification unit 12 identifies a first customer who pays. The database information of FIG. 4 is acquired by associating information (a customer name, a customer member number, an employee number, and the like) for identifying the customer with a feature value of the face of the customer. The database information of FIG. 4 may further include a photograph of the face of each customer.

The identification unit 12 extracts a person from the image acquired by the acquisition unit 11 and extracts a feature value of an appearance of the person. Furthermore, the identification unit 12 collates the feature value of the person extracted from the image with the feature value, which is included in the database information, of the appearance of each of the plurality of persons, and determines a person of which a degree of similarity is equal to or larger than a reference value.

In a case where it is possible to determine the person of which the degree of similarity is equal to or larger than the reference value in the database information, the information for identifying the person is output as an identification result. On the other hand, in a case where it is not possible to determine the person of which the degree of similarity is equal to or larger than the reference value in the database information, “no person concerned” is output as the identification result. Details of a collation process are not particularly limited and it is possible to realize the collation process by applying various technologies.

It should be noted that, it is possible for the identification unit 12 to start the authentication process in order to identify the first customer before the operation of starting the settlement process with respect to the first customer is performed. Therefore, it is possible to identify the first customer before the operation of starting the settlement process with respect to the first customer is performed.

For example, in a case where a product registration process with respect to the first customer starts, the identification unit 12 may start the authentication process in order to identify the first customer according to the start of the product registration process. The judgement unit 14 illustrated in FIG. 15 may judge that the product registration process with respect to the first customer starts. For example, in a case where an initial product registration is performed, it is possible for the judgement unit 14 to judge that the product registration process starts. Note that, the identification unit 12 may start the authentication process in order to identify the first customer according to another operation before the operation of starting the settlement process is performed. For example, the identification unit 12 may start the authentication process in order to identify the first customer with a prescribed event (for example: the operation of starting the settlement process, output of a receipt or a coupon, or output of change), which occurs while a settlement process (the registration process, the checkout process, the settlement process, or the like) is being performed with respect to a customer (a second customer) before the first customer, as a trigger. For example, in a case where the operation of starting the settlement process is performed with respect to the second customer on which the settlement process is performed before the first customer, the identification unit 12 may start to identify the first customer. Here, the second customer may be a customer immediately before the first customer or may be a customer before a prescribed number of persons.

In a case where the first camera captures the moving image and the authentication process starts, the identification unit 12 performs a process of deciding an image (for example: an image of the newest frame at that point of time) of a prescribed frame as a processing target, and identifying the person included in the image. Thereafter, while using an image of each of the subsequent frames at prescribed time intervals as the processing target, the identification unit 12 may continue a process of identifying the persons included in each image. That is, after the process of identifying the persons included in the image starts, the identification unit 12 may sequentially process the images (images of the frames at prescribed time intervals) of the plurality of frames which are subsequently generated, and may identify the persons included in each image.

In this case, the identification unit 12 ends the authentication process with respect to the first customer at a previously decided end timing. The end timing may be a timing in which the operation of starting the settlement process with respect to the first customer is performed, a timing in which the registration process starts with respect to a subsequent customer, or the like. That is, it is possible to configure the identification unit 12 so as to start the process with respect to a subsequent customer (a third customer) of the first customer after the authentication process with respect to the first customer ends. In addition, it is possible to configure the identification unit 12 so as to start the process with respect to the subsequent customer (the third customer) of the first customer at the same time that the authentication process with respect to the first customer ends.

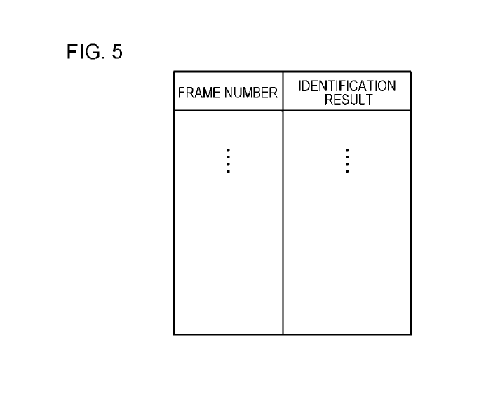

In a case where the first camera captures the moving image, a plurality of identification results are accumulated with respect to the first customer (refer to FIG. 5). That is, the identification results (information for identifying the extracted person or no person concerned) are accumulated for respective frames. It is possible for the above-described checkout unit 21 to perform the above-described settlement process using a prescribed identification result of the plurality of identification results. For example, the checkout unit 21 may perform the settlement process using the newest identification result (for example: the newest identification result among the identification results accumulated until that point of time or an identification result based on the newest image among the images acquired until that point of time) at a point of time in which the operation of starting the settlement process with respect to the first customer is performed. Furthermore, in a case where the newest identification result is no person concerned or the process of identifying does not end (it is not possible to identify the first customer), the settlement process may be performed using another identification result which is extracted under a prescribed search condition. An identification result of an immediately before frame of the newest frame may be used as another identification result or a result of the newest frame among the frames in which the identification result is capable of identifying the extracted person may be used as another identification result. In a case where another identification result is also no person concerned, another identification result may be further extracted under a prescribed search condition. Furthermore, in a case where the identification results, which are extracted in succession as many as a prescribed number, are no person concerned, the checkout unit 21 may perform the settlement process using a different method from the settlement process using the face authentication process. In addition, in a case where it is not possible to identify the first customer in the newest image at a point of time in which the operation of starting the settlement process with respect to the first customer is performed, the checkout unit 21 may perform the settlement process with respect to the first customer who is identified in an image which is acquired before the newest image.

Subsequently, in a case where the first camera captures the still image, the acquisition unit 11 may request an image from the first camera at a prescribed timing (a timing in which the identification unit 12 starts the authentication process). Furthermore, the identification unit 12 may use the still image, which is generated by the first camera by the request, as the processing target, and may perform the process of identifying the persons included in the image. In a case where it is not possible to determine the person of which the degree of similarity is equal to or larger than the reference value in the database information, the acquisition unit 11 and the identification unit 12 may repeatedly perform the request of the image and identification of the persons included in the image until it is possible to determine the person of which the degree of similarity is equal to or larger than the reference value in the database information while using the prescribed number of times as an upper limit. Furthermore, in a case where it is possible to determine the person of which the degree of similarity is equal to or larger than the reference value in the database information, the information for identifying the person may be output as the identification result. On the other hand, in a case where it is not possible to determine the person of which the degree of similarity is equal to or larger than the reference value in the database information even through repetition performed as many as the prescribed number of times, “no person concerned” may be output as the identification result. In a case where the information for identifying the person is output as the identification result, the above-described checkout unit 21 performs the settlement process using the information. On the other hand, in a case where no person concerned is output as the identification result, the checkout unit 21 performs the settlement process using a different method from the settlement process using the face authentication process.

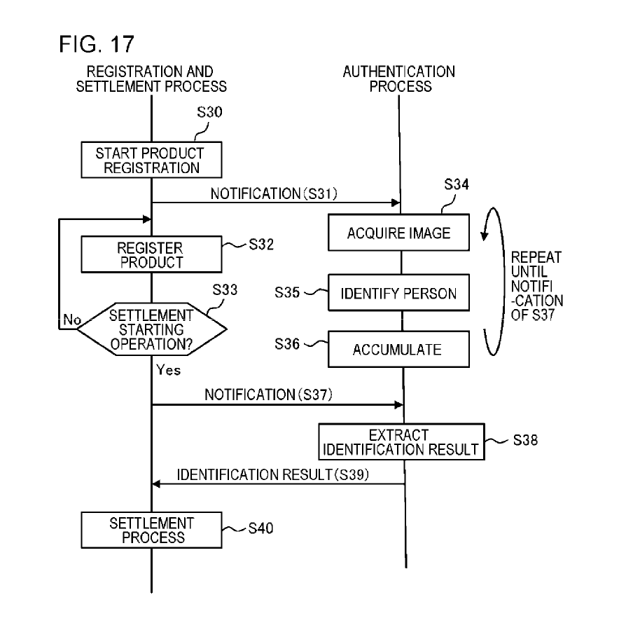

Subsequently, an example of a flow of a process of the information processing system 100 of the present example embodiment will be described with reference to a sequence diagram of FIG. 17. Here, a process performed in a case where the acquisition unit 11 acquires the moving image will be described.

The information processing system 100 performs a registration and settlement process and the authentication process in parallel. First, in a case where the product registration process starts in the registration and settlement process (S30), a notification thereof is provided to the authentication process (S31). According to the notification, the process of identifying the customer starts in the authentication process. Specifically, an image is acquired (S34), and the process of identifying the persons included in the image is performed (S35). Furthermore, the identification results (the information for identifying the extracted person or no person concerned) are accumulated (S36). In the authentication process, S34 to S36 are repeated until a notification of S37 is received.

On the other hand, in the registration and settlement process, product registration is received even after the product registration process of S30 starts (S32). While the operation of starting the settlement process is not performed (No in S33), the product registration is received (S32). In a case where the operation of starting the settlement process is performed (Yes in S33), a notification thereof is provided to the authentication process (S37).

In the authentication process, for example, the process of identifying the customer (S34 to S36) ends according to the notification of S37. Furthermore, from among the identification results (in which the information for identifying the person or no person concerned is associated with each of the frames on which the image analysis is performed) which are accumulated by that time, a prescribed identification result (the information for identifying the person or no person concerned, which is associated with the prescribed frame) is extracted (S38), and the prescribed identification result is notified to the registration and settlement process (S39).

Furthermore, for example, the newest identification result may be extracted at a point of time in which the notification in S37 is provided. Furthermore, in a case where the newest identification result is the information for identifying the person, the identification result may be notified to the registration and settlement process. On the other hand, in a case where the newest identification result is no person concerned, another identification result may be extracted under a prescribed search condition. Furthermore, in a case where another identification result is the information for identifying the person, the identification result may be notified to the registration and settlement process. On the other hand, in a case where another identification result is no person concerned, another identification result may be further extracted under a prescribed search condition. Furthermore, in a case where the identification result is no person concerned in succession as many as a prescribed number, no person concerned may be notified to the registration and settlement process.

In the registration and settlement process, the settlement process is performed based on the identification result acquired in S39 (S40). In a case where the information for identifying the person is acquired as the identification result, for example, it is possible to acquire the electronic money information or the point information, which corresponds to the information for identifying the person, from the server, and to perform the settlement process using the electronic money information or the point information. On the other hand, in a case where no person concerned is acquired as the identification result, it is possible to perform the settlement process using, for example, another method.

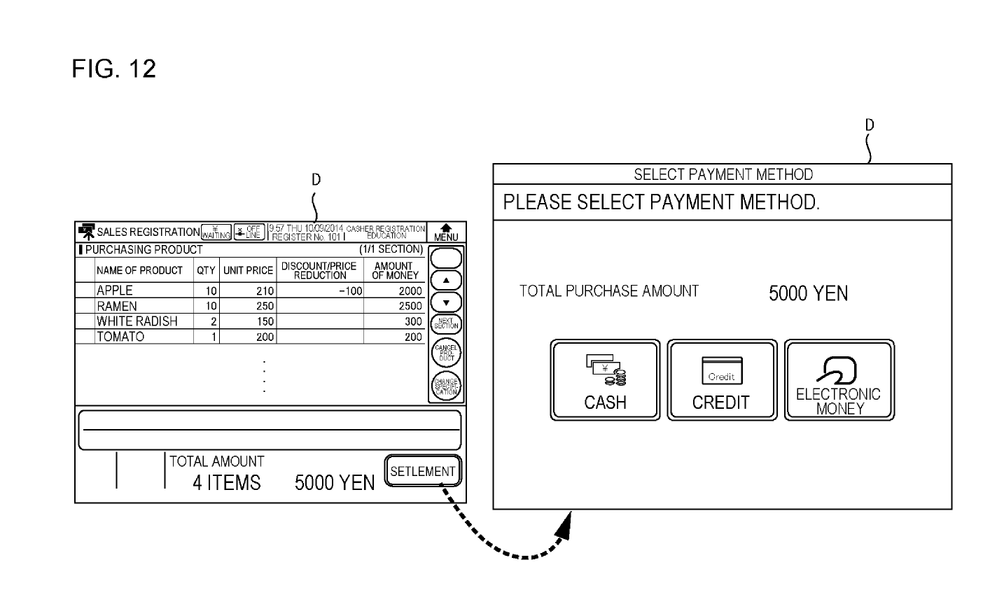

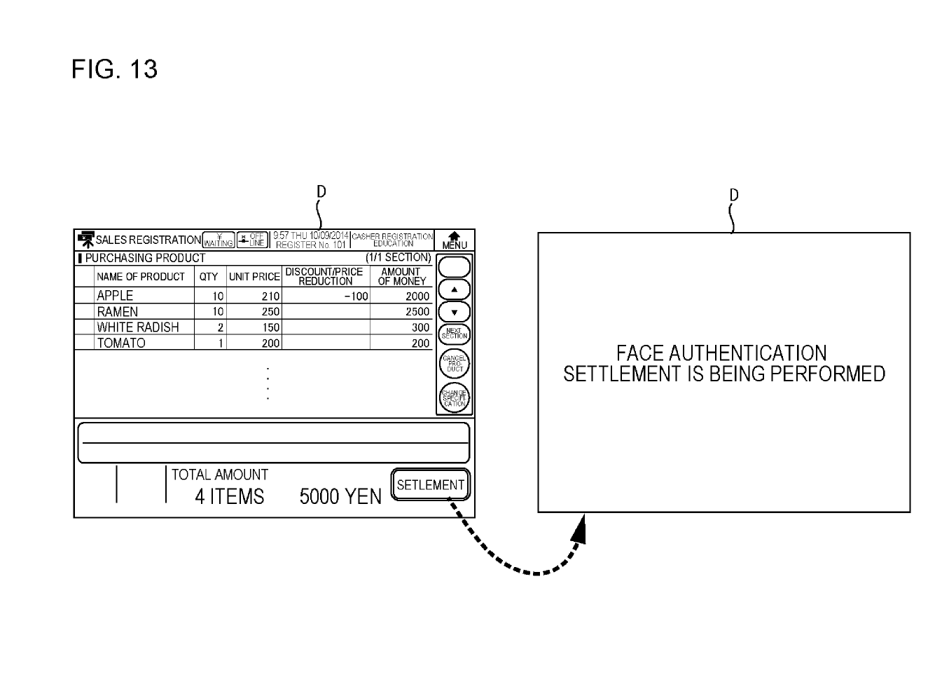

Here, an example of a screen, which is displayed on the information processing system 100, will be described with reference to FIGS. 12 and 13. The display is controlled by the display control unit. First, a screen D, which is acquired while the registration process is being performed, is illustrated on a left side of FIGS. 12 and 13. On the screen D, which is acquired while the registration process is being performed, a list of pieces of information (a name, the number, price, and the like) of registered products, the total amount of money, and the like are displayed. In a case of the example, an operation of touching an area “settlement”, which is illustrated in the drawing, is the operation of starting the settlement process.

In a case where the operation of starting the settlement process is performed, the screen is transferred according to the operation. In a case where the identification result acquired in S39 is the information for identifying the person, for example, the settlement process using the information for identifying the person is performed. It is possible to display a screen (a screen which provides a notification that the registration process is being performed), which corresponds to the settlement process illustrated on a right side of FIG. 13, on the display during the settlement process. Here, it is possible for the display control unit to display the screen (the screen which provides the notification that the settlement process is being performed), which corresponds to the settlement process, on the display.

It should be noted that, in the registration and settlement process, before the settlement process using the information for identifying the person (the identification result) acquired in S39 starts, the image generated by the first camera and an image (an image which is previously registered together with the feature value) of the person corresponding to the identification result may be displayed on the display, and an inquiry of whether or not there is no problem in an authentication result may be provided to the operator. Furthermore, in a case where an input having a gist that there is no problem is received, the settlement process using the information for identifying the person may be performed.

On the other hand, in a case where the identification result acquired in S39 is no person concerned, the information processing system 100 may display a screen for receiving selection of the payment method, on the display, as illustrated on a right side of FIG. 12. Thereafter, it is possible to perform the settlement process according to the selection.

According to the above-described information processing system 100 of the present example embodiment, in a case where, for example, the product registration process starts before the operation of starting the settlement process is performed, it is possible to start the process of identifying the customer using the image. Therefore, it is possible to perform the process of identifying the customer in parallel with the process of registering the product to be checked out. In such a case, it is expected that the customer identification is completed at a point of time in which the operation of starting the settlement process is performed. Furthermore, in a case where the operation of starting the settlement process is performed, it is possible to start the settlement process using the identification result which is acquired at the point of time, according to the operation. As a result, it is possible to suppress waiting time for the face authentication process while the settlement is being performed using the face authentication process.

In addition, it is possible for the information processing system 100 of the present example embodiment to process each of the images of the plurality of frames included in the moving image, to identify the persons included in each of the images, and to perform the settlement process based on the prescribed identification result thereamong. Here, even in a case where it is not possible to identify a customer at a certain timing but it is possible to identify the customer at another timing, it is possible to perform the settlement process using the identification result. As a result, convenience is improved.

<SECOND EXAMPLE EMBODIMENT>

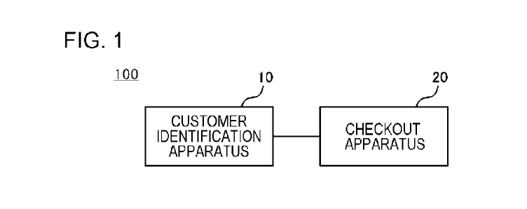

First, a whole image and an outline of the information processing system 100 of the present example embodiment will be described with reference to FIG. 1. As illustrated in the drawing, the information processing system 100 includes a customer identification apparatus 10 and a checkout apparatus 20. The information processing system 100 realizes a prescribed process through a process cooperated by the customer identification apparatus 10 and the checkout apparatus 20. Although a realization example will be described below, the customer identification apparatus 10 and the checkout apparatus 20 may be configured to be physically and/or logically integrated, or may be configured to be physically and/or logically separated.

The checkout apparatus 20 performs a process of registering a product to be checked out (registration process) and a settlement process. An operator (a sales clerk or a customer) registers the product to be checked out in the checkout apparatus 20 through a prescribed input apparatus. Furthermore, in a case where product registration is completed, the operator performs an operation of starting the settlement process through the prescribed input apparatus.

The customer identification apparatus 10 identifies the customer who is performing settlement based on an image generated by a first camera, which is installed in a vicinity of the checkout apparatus 20, and database information in which a feature value of an appearance of each of a plurality of persons is registered. It is possible for the customer identification apparatus 10 to start a process of identifying the customer before the operation of starting the settlement process is performed with respect to the checkout apparatus 20. Furthermore, the customer identification apparatus 10 notifies an identification result (information for identifying the extracted person or no person concerned) to the checkout apparatus 20.

The checkout apparatus 20 performs the settlement process using the identification result (information for identifying the extracted person or no person concerned) acquired from the customer identification apparatus 10. For example, the checkout apparatus 20 acquires electronic money information, point information, or the like, which corresponds to the information for identifying the person, from a prescribed database, and performs the settlement process using the acquired information. In addition, in a case of the information processing system 100 in a store installed in an inside of an organization such as a company, a settlement process may be performed by accumulating the amount of money to be paid in association with information (for example: employee number) for identifying the customer within the organization, and deducting the amount of money to be paid from salaries. Note that, it may be possible for the checkout apparatus 20 to perform the settlement process using cash, a credit card, another type of electronic money, another type of point, and the like. For example, in a case where it is not possible to identify the customer through a process using the image, the settlement process may be performed using another method which is illustrated.

According to the information processing system 100 of the present example embodiment, it is possible to start the process of identifying the customer using the image before the operation of starting the settlement process is performed. Therefore, it is possible to perform the process of identifying the customer in parallel with the process of registering the product to be checked out. Here, it is expected that identification of the customer is completed at a point of time in which the operation of starting the settlement process is performed. Furthermore, in a case where the operation of starting the settlement process is performed, it is possible to start the settlement process using information for identifying the customer who is identified at the point of time according to the operation. As a result, it is possible to suppress waiting time for the face authentication process while the settlement is performed using the face authentication process.

Subsequently, a configuration of the customer identification apparatus 10 and the checkout apparatus 20 will be described. First, an example of a hardware configuration of the customer identification apparatus 10 and the checkout apparatus 20 will be described. Each of the functional units which are included in the customer identification apparatus 10 and the checkout apparatus 20 of the present example embodiment are realized by any combination of hardware and software of any computer based on a CPU, a memory, a program which is loaded on the memory, a storage unit (which is capable of storing a program which is downloaded from a storage medium, such as CD, a server on the Internet, or the like, in addition to a program that is previously stored from a stage in which an apparatus is delivered), such as a hard disk, which stores the program, and an interface for network connection. Furthermore, those skilled in the art understand that various modification examples exist for a realization method and an apparatus thereof.

FIG. 2 is a block diagram illustrating the hardware configuration of the customer identification apparatus 10 and the checkout apparatus 20 of the present example embodiment. As illustrated in FIG. 1, the customer identification apparatus 10 and the checkout apparatus 20 include the processor 1A, the memory 2A, the input and output interface 3A, the peripheral circuit 4A, and the bus 5A. The peripheral circuit 4A includes various modules. Note that, in a case where the customer identification apparatus 10 and the checkout apparatus 20 are configured to be physically and/or logically separated, each of the customer identification apparatus 10 and the checkout apparatus 20 includes the hardware configuration as illustrated in FIG. 1.

The bus 5A is a data transmission path which is used for the processor 1A, the memory 2A, the peripheral circuit 4A, and the input and output interface 3A to transmit and receive data to and from each other. The processor 1A is, for example, an arithmetic processing unit such as a CPU or a GPU. The memory 2A is, for example, a memory such as a RAM or a ROM. The input and output interface 3A includes an interface which is used to acquire information from an input apparatus (for example: a keyboard, a mouse, a microphone, a physical key, a touch panel display, a code reader, or the like), an external apparatus, an external server, an external sensor, and the like, and an interface which is used to output information to an output apparatus (for example: a display, a speaker, a printer, an emailer, or the like), the external apparatus, the external server, and the like. It is possible for the processor 1A to output an instruction to each of the modules and to perform an arithmetic operation based on an arithmetic result of each of the modules.

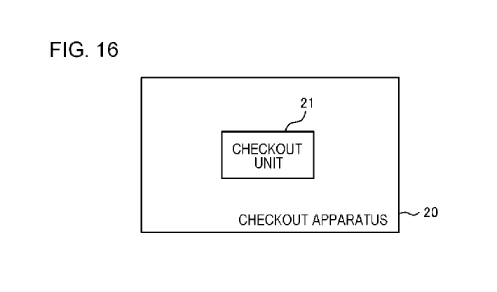

Subsequently, a functional configuration of the checkout apparatus 20 will be described. FIG. 16 illustrates an example of a functional block diagram of the checkout apparatus 20. As illustrated in the drawing, the checkout apparatus 20 includes a checkout unit 21. Although not illustrated in the drawing, the checkout apparatus 20 may further include a display control unit. Functions of the checkout unit 21 and the display control unit are the same as the function of the checkout unit 21 which is described in the first example embodiment.

It should be noted that, the checkout apparatus 20 is configured to exchange information between the checkout apparatus 20 and the customer identification apparatus 10. For example, the checkout apparatus 20 acquires information for identifying the customer from the customer identification apparatus 10.

In addition, the checkout apparatus 20 notifies that a prescribed operation is performed to the customer identification apparatus 10. As an example, in a case where a prescribed operation, which is performed before the operation of starting the settlement process is performed, is performed in the settlement process (the registration process, the settlement process, or the like) with respect to a certain customer, the checkout apparatus 20 may notify that the operation is to be performed to the customer identification apparatus 10 according to the operation. For example, the checkout apparatus 20 may notify that an initial product registration is performed in the settlement process with respect to the customer to the customer identification apparatus 10. As another example, the checkout apparatus 20 may notify that the operation of starting the settlement process is performed to the customer identification apparatus 10.

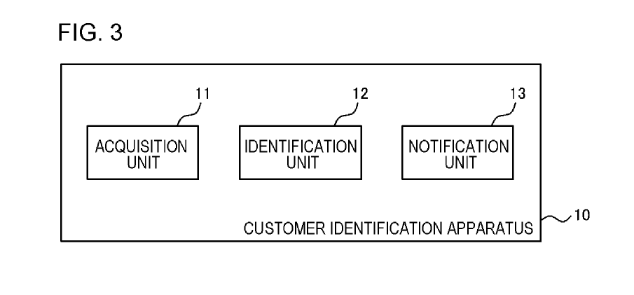

Subsequently, a functional configuration of the customer identification apparatus 10 will be described. FIG. 3 illustrates an example of the functional block diagram of the customer identification apparatus 10. As illustrated in the drawing the, customer identification apparatus 10 includes an acquisition unit 11, an identification unit 12, and a notification unit 13.

A configuration of the acquisition unit 11 is the same as the configuration of the acquisition unit 11 which is described in the first example embodiment. A configuration of the identification unit 12 is the same as the configuration of the identification unit 12 which is described in the first example embodiment.

The notification unit 13 notifies an identification result acquired by the identification unit 12 to the checkout apparatus 20. For example, the notification unit 13 notifies the identification result, such as “information for identifying a customer (first customer)” or “no person concerned”, which is identified by the identification unit 12, to the checkout apparatus 20. Also, in a case of “no person concerned”, a configuration is possible in which a notification is not provided. In addition, a configuration is possible in which a notification of a number of a credit card is provided instead of the information for identifying the customer. Furthermore, in a case where another settlement method exists, a settlement method corresponding to the identified customer may be notified.

Subsequently, an example of a flow of a process of the information processing system 100 of the present example embodiment will be described with reference to a sequence diagram of FIG. 17. Here, a process performed in a case where the acquisition unit 11 acquires a moving image will be described. Note that, a registration and settlement process illustrated in the drawing is a process of the checkout apparatus 20. The authentication process illustrated in the drawing is a process of the customer identification apparatus 10.

The information processing system 100 performs the registration and settlement process performed by the checkout apparatus 20 and the authentication process performed by the customer identification apparatus 10 in parallel. First, in a case where the product registration process starts (S30), the checkout apparatus 20 provides a notification thereof to the customer identification apparatus 10 (S31). According to the notification, the customer identification apparatus 10 starts the process of identifying the customer. Specifically, the customer identification apparatus 10 acquires the image (S34), and performs a process of identifying the persons included in the image (S35). Furthermore, the customer identification apparatus 10 accumulates identification results (information for identifying the extracted person or no person concerned) (S36). The customer identification apparatus 10 repeats S34 to S36 until a notification of S37 is received.

On the other hand, the checkout apparatus 20 receives product registration even after the product registration process of S30 starts (S32). While the operation of starting the settlement process is not performed (No in S33), the checkout apparatus 20 receives the product registration (S32). In a case where the operation of starting the settlement process is performed (Yes in S33), the checkout apparatus 20 provides a notification thereof to the customer identification apparatus 10 (S37).

The customer identification apparatus 10 ends the process of identifying the customer (S34 to S36) according to, for example, the notification f S37. Subsequently, the notification unit 13 of the customer identification apparatus 10 extracts a prescribed identification result from among the identification results which are accumulated by that time (S38), and notifies the extracted identification result to the checkout apparatus 20 (S39).

For example, the notification unit 13 may extract the newest identification result at a point of time in which the notification of S37 is provided. Furthermore, in a case where the newest identification result is the information for identifying the person, the notification unit 13 may notify the identification result to the checkout apparatus 20. On the other hand, in a case where the newest identification result is no person concerned, the notification unit 13 may extract another identification result under a prescribed search condition. Furthermore, in a case where another identification result is the information for identifying the person, the notification unit 13 may notify the identification result to the checkout apparatus 20. On the other hand, in a case where another identification result is no person concerned, the notification unit 13 may further extract another identification result under a prescribed search condition. Furthermore, in a case where the identification result is no person concerned in succession as many as a prescribed number, the notification unit 13 may notify no person concerned to the checkout apparatus 20.

The checkout apparatus 20 performs the settlement process based on the identification result acquired in S39 (S40). In a case where the information for identifying the person is acquired as the identification result, it is possible for the checkout apparatus 20 to acquire, for example, the electronic money information or the point information, which corresponds to the information for identifying the person, from the server, and to perform the settlement process using the electronic money information or the point information. On the other hand, in the case where no person concerned is acquired as the identification result, it is possible for the checkout apparatus 20 to perform the settlement process using, for example, another method.

Here, an example of a screen, which is displayed on a display of the checkout apparatus 20, will be described with reference to FIGS. 12 and 13. First, a screen D, which is acquired while the registration process is being performed, is illustrated on a left side of FIGS. 12 and 13. On the screen D, which is acquired during the registration process, a list of pieces of information (a name, the number, price, and the like) of registered products, the total amount of money, and the like are displayed. In a case of the example, an operation of touching an area “settlement”, which is illustrated in the drawing, is the operation of starting the settlement process.

In a case where the operation of starting the settlement process is performed, the screen is transferred according to the operation. In a case where the identification result acquired in S39 is the information for identifying the person, for example, the settlement process using the information for identifying the person is performed. It is possible to display a screen (a screen which provides a notification that the settlement process is being performed), which corresponds to the settlement process illustrated on a right side of FIG. 13, on the display during the settlement process.

It should be noted that, the checkout apparatus 20 may display the image generated by the first camera and an image (an image which is previously registered together with the feature value) of the person corresponding to the identification result on the display before the settlement process using the information for identifying the person (the identification result) acquired in S39 starts, and may provide an inquiry of whether or not there is no problem in an authentication result to an operator. Furthermore, in a case where the checkout apparatus 20 receives an input having a gist that there is no problem, the checkout apparatus 20 may perform the settlement process using the information for identifying the person.

On the other hand, in a case where the identification result acquired in S39 is no person concerned, the checkout apparatus 20 may display a screen for receiving selection of the payment method, on the display, as illustrated on the right side of FIG. 12. Thereafter, it is possible for the checkout apparatus 20 to perform the settlement process according to the selection.

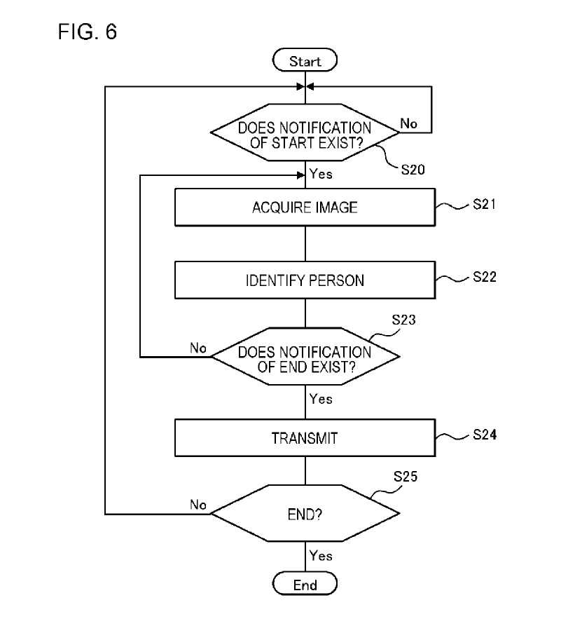

Subsequently, an example of a flow of a process of the customer identification apparatus 10 of the present example embodiment will be described with reference to a flowchart of FIG. 6. The example of the process is an example in a case where the acquisition unit 11 acquires the moving image from the first camera.

First, the customer identification apparatus 10 becomes a notification waiting state in order to start the process of identifying the persons included in the image (S20). Furthermore, in a case where a prescribed notification is received from the checkout apparatus 20 (Yes in S20), the customer identification apparatus 10 starts the process of identifying the persons included in the image. Note that, the notification used to start the process of identifying the persons included in the image is, for example, a notification (for example: a notification that the initial product registration is performed) that the prescribed operation is performed before the operation of starting the settlement process is performed while the settlement process (the registration process, the settlement process, or the like) is performed with respect to a certain customer.

In S21, the identification unit 12 acquires an image to be processed from the acquisition unit 11. In S22, the identification unit 12 identifies the persons included in the image based on the image acquired in S21 and database information in which a feature value of an appearance of each of a plurality of persons is registered. Thereafter, in a case where a notification, which is used to end the process of identifying the persons included in the image, is not provided (No in S23), the process returns to S21 again, and an image of a subsequent frame is acquired. Thereafter, the same process is repeated. As a result, the identification result in S22 is accumulated.

Furthermore, in a case where the notification, which is used to end the process of identifying the persons included in the image, is received from the checkout apparatus 20 (Yes in S23), the process proceeds to S24. The notification, which is used to end the process of identifying the persons included in the image, is, for example, a notification that the operation of starting the settlement process is performed.

In S24, the notification unit 13 notifies a prescribed identification result among the identification results accumulated by that time to the checkout apparatus 20. Thereafter, the process returns to S20, and the state becomes the notification waiting state in order to start the process of identifying the persons included in the image again.

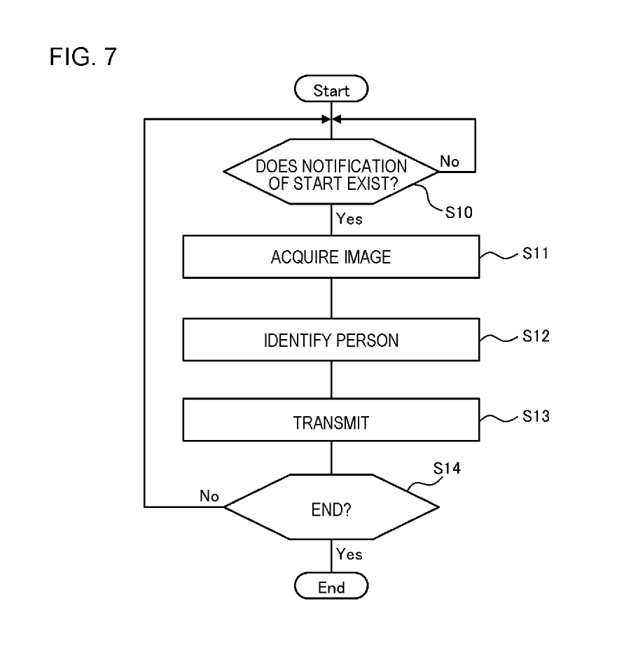

Subsequently, an example of a flow of a process of the customer identification apparatus 10 of the present example embodiment will be described with reference to a flowchart of FIG. 7. The example of the process is an example in a case where the acquisition unit 11 acquires a still image from the first camera.

First, the customer identification apparatus 10 becomes the notification waiting state in order to start the process of identifying the persons included in the image (S10). Furthermore, in a case where the prescribed notification is received from the checkout apparatus 20 (Yes in S10), the customer identification apparatus 10 starts the process of identifying the persons included in the image. Note that, the notification used to start the process of identifying the persons included in the image is, for example, a notification (for example: a notification that the initial product registration is performed) that the prescribed operation is performed before the operation of starting the settlement process is performed while the settlement process (the registration process, the settlement process, or the like) is performed with respect to the certain customer.

In S11, the acquisition unit 11 requests an image from the first camera, and acquires the image, which is captured according to the request, from the first camera. Furthermore, the identification unit 12 acquires the image from the acquisition unit 11.

In S12, the identification unit 12 identifies the persons included in the image based on the image acquired in S11 and database information in which a feature value of an appearance of each of a plurality of persons is registered. In S13, the notification unit 13 notifies the identification result acquired by the identification unit 12 to the checkout apparatus 20. Thereafter, the process returns to S10, and the notification waiting state in order to start the process of identifying the persons included in the image is made again.

Subsequently, a realization example of the information processing system 100 of the present example embodiment, which is realized by the customer identification apparatus 10 and the checkout apparatus 20, will be described.

The customer identification apparatus 10 and the checkout apparatus 20 may be realized by one apparatus which is physically and/or logically integrated. For example, the customer identification apparatus 10 and the checkout apparatus 20 may be realized by one POS register.

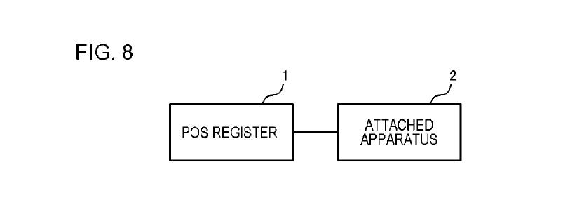

As illustrated in FIG. 8, the customer identification apparatus 10 and the checkout apparatus 20 may be realized by a POS register 1 and an attachment apparatus 2, which are physically and/or logically separated. The POS register 1 and the attachment apparatus 2 are configured to be able to communicate with each other in wired and/or wireless manner. The POS register 1 and the attachment apparatus 2 may be connected one to one as illustrated in the drawing, or a plurality of POS registers 1 may be connected to one attachment apparatus 2.

In a case of an example of FIG. 8, the checkout apparatus 20 may be realized by the POS register 1 and the customer identification apparatus 10 may be realized by the attachment apparatus 2.

In addition, the checkout apparatus 20 and a partial function of the customer identification apparatus 10 may be realized by the POS register 1, and another partial function of the customer identification apparatus 10 may be realized by the attachment apparatus 2. For example, the acquisition unit 11 of the customer identification apparatus 10 and the partial function (for example: a function of extracting a person from an image and a function of extracting a feature value of the person) of the identification unit 12 may be realized by the POS register 1. Furthermore, another partial function (for example: a function of collating the feature value of the person extracted from the image with database information in which the feature value of the appearance of each of the plurality of persons is registered) of the identification unit 12, and the notification unit 13 may be realized by the attachment apparatus 2.

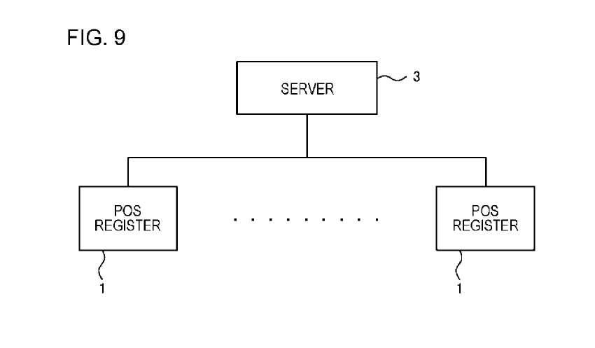

In addition, as illustrated in FIG. 9, the customer identification apparatus 10 and the checkout apparatus 20 may be realized by the POS register 1 and a server 3 which are physically and/or logically separated. The POS register 1 and the server 3 are configured to be able to communicate with each other in wired and/or wireless manner. As illustrated in the drawing, a plurality of POS registers 1 are connected to one server 3.

In a case of an example of FIG. 9, the checkout apparatus 20 may be realized by the POS register 1, and the customer identification apparatus 10 may be realized by the server 3.

In addition, the checkout apparatus 20 and a partial function of the customer identification apparatus 10 may be realized by the POS register 1, and another partial function of the customer identification apparatus 10 may be realized by the server 3. For example, the acquisition unit 11 of the customer identification apparatus 10 and the partial function (for example: a function of extracting a person from an image and a function of extracting a feature value of the person) of the identification unit 12 may be realized by the POS register 1. Furthermore, another partial function (for example: a function of collating the feature value of the person extracted from the image with database information in which the feature value of the appearance of each of the plurality of persons is registered) of the identification unit 12 and the notification unit 13 may be realized by the server 3.

Here, a modification example will be described. The information processing system 100 may include a unit that causes the face of the customer to be turned toward the first camera such that it is possible to capture an image in a state in which it is easy to identify the customer. For example, the information processing system 100 may cause the face of the customer to be turned toward the first camera by displaying prescribed information on the display installed in a vicinity of the first camera. For example, the face of the customer may be caused to be turned toward the first camera by displaying a selection screen on the display. Specifically, a configuration may be provided in which a screen used to select whether a plastic shopping bag is needed or not is displayed so as to change the direction of the face of the customer. Furthermore, as to a timing in which the plastic shopping bag is needed or not is displayed, it is preferable that the display is performed after the checkout apparatus 20 provides a notification used to start the process of identifying the customer to the customer identification apparatus 10. In addition, the information processing system 100 may cause the customer to turn attention to the first camera by outputting a prescribed voice from a speaker installed in the vicinity of the first camera. In addition, the information processing system 100 may cause the customer to turn attention to the first camera by switching on and off a lamp installed in the vicinity of the first camera.

Another modification example will be described. The information processing system 100 may further include a second acquisition unit that acquires an image generated by a second camera installed in another location, and a second identification unit that identifies a person who visits a store based on the database information in which the feature value of the appearance of each of a plurality of persons is registered. Furthermore, the identification unit 12 of the customer identification apparatus 10 may identify the persons included in the image generated by the first camera based on the database information of a person group identified by the second identification unit. Here, it is possible to reduce the number of pieces of information to be collated in order to identify the persons included in the image generated by the first camera. As a result, it is possible to improve a speed of a collation process.

The second camera is installed in any location in the store. For example, the second camera may be installed in an entrance of the store. Note that, the customer identification apparatus 10 may include a previous step identification unit, or another apparatus which is physically and/or logically separated from the customer identification apparatus 10 and the checkout apparatus 20 may include the previous step identification unit. In this case, the customer identification apparatus 10 and another apparatus are configured to be able to communicate with each other in wired and/or wireless manner.

Also, a configuration is possible in which the information processing system 100 further includes a customer database and database generation unit, in addition to the second acquisition unit and the second identification unit. The second identification unit extracts a person from the image acquired from the second camera, and extracts a feature value of an appearance of the person. Furthermore, the second identification unit collates the feature value of the person extracted from the image with the feature value, which is included in the database information, of the appearance of each of the plurality of persons, and determines a person of which a degree of similarity is equal to or larger than a reference value. The database generation unit stores information (a name, a member number, an employee number, or the like) for identifying the person identified by the second identification unit in association with a feature value of the face of the person in the customer database. The customer database stores the information (the name, the member number, the employee number, or the like) for identifying a customer who visits the store, in which the second camera is installed, in association with a feature value of the face of the customer. Also, it is possible to provide a configuration in which the customer database stores all the customers who visit the store so far, a configuration in which leaving of the customer from the store is detected and the customer is deleted from the customer database at the time of the customer leaving the store, or a configuration in which information stored in the customer database is deleted after a prescribed period elapses (one day, one week, or the like). The identification unit 12 identifies the customer based on the constructed customer database and a facial image of the customer acquired from the first camera.

Another modification example will be described. The image, which is acquired from the first camera by the acquisition unit 11, is temporarily stored in a storage apparatus of the customer identification apparatus 10. Furthermore, the customer identification apparatus 10 may remove the image from the storage apparatus at a prescribed timing. For example, in a case where a notification of the identification result is provided to the checkout apparatus 20 by the notification unit 13, images accumulated in the storage apparatus by that time may be removed according to the notification. In this manner, individual information of the visitor is protected.

Another modification example will be described. The information processing system 100 may further store an image (registration image) of each of the plurality of persons in the database information in which the feature value of the appearance of each of the plurality of persons is stored. Furthermore, the information processing system 100 may display the image which is generated by the first camera, and the registration image of the person who is identified by the customer identification apparatus 10 on the display (for example: the display of the checkout apparatus 20) side by side. The display may be directed toward the operator (the sales clerk or the customer) who operates the checkout apparatus 20, or may be directed toward a waiting customer while the sales clerk operates the checkout apparatus 20. Therefore, it is possible for the sales clerk or the customer to detect customer recognition error by the information processing system 100.

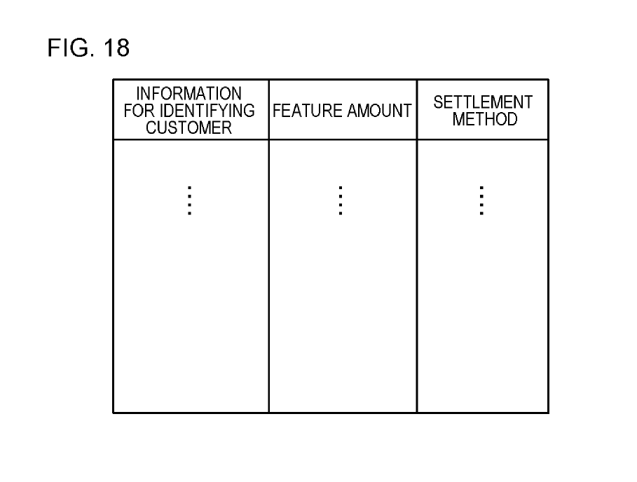

Another modification example will be described. The information processing system 100 may register a payment method specified by the customer for each customer, as illustrated in FIG. 18. Furthermore, the information processing system 100 may perform the settlement process using a settlement method corresponding to the information for identifying the customer who is identified using the image.

It should be noted that, it is possible to apply all the modification examples described above to another example embodiment.

According to the above-described information processing system 100 of the present example embodiment, an advantageous effect which is the same as in the first example embodiment is acquired. In addition, as illustrated in FIGS. 8 and 9, with a configuration in which the information processing system 100 is realized by the POS register 1 and another apparatus (the attachment apparatus 2 or the server 3), it is possible to use an existing POS register 1 which does not include a function of executing the face authentication process. As a result, it is possible to save costs for introducing a new system.

### Third Example Embodiment

The example embodiment is a modification example of the second example embodiment. In the second example embodiment, which is described with reference to FIG. 6, an example is described in which the customer identification apparatus 10 accumulates the plurality of identification results acquired by processing the moving image and provides the notification to the checkout apparatus 20 by extracting one of the identification results at the prescribed timing. In the present example embodiment, the customer identification apparatus 10 may transmit the plurality of identification results, which are acquired by processing the moving image in succession, to the checkout apparatus 20. Furthermore, the plurality of identification results may be accumulated in the storage apparatus in the checkout apparatus 20. Here, the checkout apparatus 20 extracts one of the plurality of accumulated identification results at any timing (timing in which the operation of starting the settlement process is performed), and performs the settlement process using the extracted identification result. The process of extracting one of the plurality of identification results is the same as the process performed by the above-described notification unit 13. It is possible for the information processing system 100 of the present example embodiment to realize the same advantageous effects as in the first and second example embodiments.

### Fourth Example Embodiment

A customer identification apparatus 10 of the present example embodiment is different from those of the second and third example embodiments in that, in a case where the customer identification apparatus 10 receives the notification that the operation of starting the settlement process is performed from the checkout apparatus 20, the customer identification apparatus 10 starts a process of identifying a person who is included in a prescribed area of the image acquired by the acquisition unit 11 as a subsequent customer (a customer who subsequently performs the settlement process) according to the notification. Another configuration of the customer identification apparatus 10 and a configuration of the checkout apparatus 20 are the same as those of the second and third the present example embodiments.

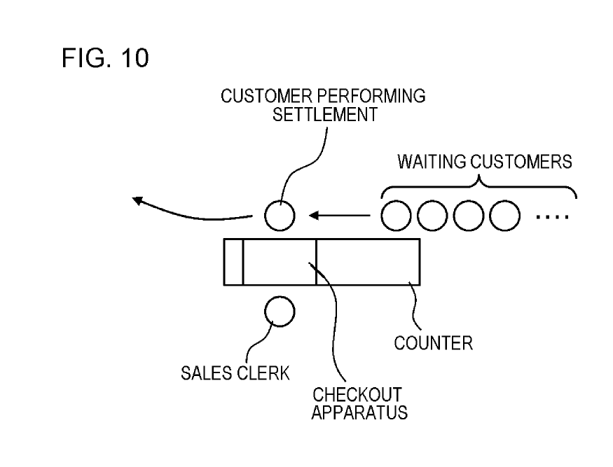

An example of a flow of a settlement process will be described with reference to FIG. 10. The checkout apparatus 20 is installed on a counter. The sales clerk who operates the checkout apparatus 20 and the customer who is performing the settlement face each other across the counter. The customer who is performing the settlement is located in front of the checkout apparatus 20 and the sales clerk. In the drawing, customers waiting for the settlement process are illustrated. In the drawing, an arrow indicates a movement direction of a customer who ends the settlement process and a movement direction of a subsequent customer following the movement.

In a case where, for example, a previous customer starts the settlement process, a customer next in line gradually moves in a direction of the arrow illustrated in the drawing while maintaining a distance from the previous customer or moves, for example, a product to be checked out, which is placed in a vicinity of a right end of the counter in the drawing, closer to the checkout apparatus 20. Furthermore, in a case where the previous customer disappears from the front of the counter, the subsequent customer further moves in the direction of the arrow and is located in front of the checkout apparatus 20 or the sales clerk.

In the present example embodiment, the first camera is installed to capture not only the customer who is performing the settlement in front of the checkout apparatus 20 and the sales clerk but also a side, starting from the location of the customer who is performing the settlement, where the waiting customer exists.

Furthermore, in a case where the identification unit 12 receives the notification that the operation of starting the settlement process from the checkout apparatus 20, the identification unit 12 starts the process of identifying a person included in the prescribed area in the image acquired by the acquisition unit 11 as the subsequent customer according to the notification.

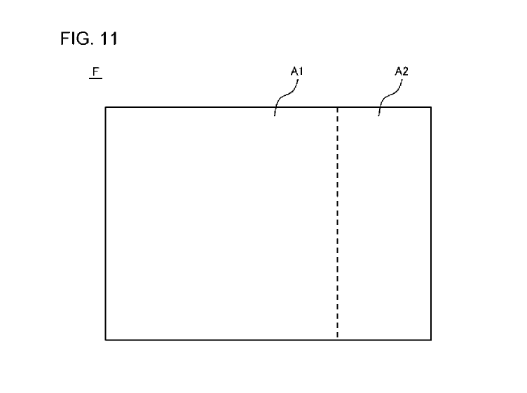

The prescribed area is an area (a fade-in area) where the subsequent customer is shown in the image. The prescribed area is decided according to an installation location or a direction of the first camera, a location where the customer who is performing the settlement exists, or a location where the customer next in line exists. For example, in the relationship shown in FIG. 10, in a case where the first camera performs capture from a lower side to an upper side in the drawing, it is possible to set an area A2 (an area on a right side) of a frame image F illustrated in FIG. 11 to the prescribed area. Note that, there is a possibility that a previous customer is shown in an area A1 (an area on a left side).

In a case where the first camera captures the moving image, after a person in the area A2 is identified, the identification unit 12 may monitor movement of the identified person. Furthermore, in a case where the person moves into the area A1, thereafter, a target area of the process of identifying the persons may be switched from the area A2 into a whole image.

It should be noted that, it is possible to use a configuration of the present example embodiment to the information processing system 100 of the first example embodiment.

According to the above-described present example embodiment, it is possible to realize the same advantageous effects as in the first to third example embodiments. In addition, according to the information processing system 100 of the present example embodiment, it is possible to start the process of identifying the customer at a timing earlier than the timing described in the first to third example embodiments. Therefore, it is possible to identify the customer in an earlier stage. As a result, it is possible to more securely suppress the waiting time for the face authentication process while the settlement is being performed using the face authentication process.

Although a part or whole of the example embodiments can be described as appendixes below, the present invention is not limited to below.

1. An information processing system including:
an acquisition unit that acquires an image, which is generated by a first camera, of a face;
an identification unit that identifies a first customer who pays, based on the acquired image and database information in which a feature value of a face is registered; and
a settlement unit that performs a settlement process with respect to the identified first customer, in which the identification unit identifies the first customer before an operation of starting the settlement process is performed.

2. The information processing system of 1,
in which the identification unit starts to identify the first customer in a case where a process of registering a product purchased by the first customer starts.

3. The information processing system of 1,
in which the identification unit starts to identify the first customer in a case where the operation of starting settlement process is performed with respect to a second customer on which the settlement process is performed previous to the first customer.

4. The information processing system of any one of 1 to 3, further including:
a display control unit that displays a screen used to select a settlement method in a case where it is not possible for the identification unit to identify the first customer.

5. The information processing system of any one of 1 to 4,
in which the acquisition unit acquires a plurality of the images, which are imaged at different timings, from the first camera, and
in which the settlement unit performs the settlement process with respect to the first customer who is identified at a newest image at a point of time in which the operation of starting the settlement process with respect to the first customer is performed.

6. The information processing system of 5,
in which the settlement unit performs the settlement process with respect to the first customer who is identified in an image which is acquired before the newest image in a case where it is not possible for the identification unit to identify the first customer in the newest image.

7. The information processing system of any one of 1 to 6, further including:
a second acquisition unit that acquires an image of a face from a second camera which is installed in a different location from the first camera; and
a generation unit that generates a customer database for identifying a customer who is visiting a store based on the image, which is acquired from the second camera, and the database information,
in which the identification unit identifies the first customer based on information of the customer database generated by the generation unit.

8. An information processing system including:
an acquisition unit that acquires an image, which is generated by a first camera, of a face;
an identification unit that identifies a first customer who pays, based on the acquired image and database information in which a feature value of a face is registered; and
a settlement unit that performs a settlement process with respect to the identified first customer,
in which the identification unit identifies the first customer in a case where a process of registering a product purchased by the first customer starts.

9. A customer identification apparatus including:
an acquisition unit that acquires an image, which is generated by a first camera, of a face;
an identification unit that identifies a first customer who pays, based on the acquired image and database information in which a feature value of a face is registered; and
a notification unit that notifies information for identifying the identified first customer corresponding to the customer to a checkout apparatus,
in which the identification unit identifies the first customer before an operation of starting the settlement process is performed.

10. An information processing method, which is executed by a computer, the method including:
an acquisition step of acquiring an image, which is generated by a first camera, of a face;
an identification step of identifying a first customer who pays, based on the acquired image and database information in which a feature value of a face is registered; and
a settlement step of performing a settlement process with respect to the identified first customer,
in which, in the identification step, the first customer is identified before an operation of starting the settlement process is performed.

11. A program causing a computer to function as:
an acquisition unit that acquires an image, which is generated by a first camera, of a face;
an identification unit that identifies a first customer who pays, based on the acquired image and database information in which a feature value of a face is registered; and
a settlement unit that performs a settlement process with respect to the identified first customer,
in which the identification unit identifies the first customer before an operation of starting the settlement process is performed.

12. An information processing method, which is executed by a computer, the method including:
an acquisition step of acquiring an image, which is generated by a first camera, of a face;
an identification step of identifying a first customer who pays, based on the acquired image and database information in which a feature value of a face is registered; and
a settlement step of performing a settlement process with respect to the identified first customer,
in which, in the identification step, the first customer is identified in a case where a process of registering a product purchased by the first customer starts.

13. A program causing a computer to function as:
an acquisition unit that acquires an image, which is generated by a first camera, of a face;
an identification unit that identifies a first customer who pays, based on the acquired image and database information in which a feature value of a face is registered; and
a settlement unit that performs a settlement process with respect to the identified first customer,
in which the identification unit identifies the first customer in a case where a process of registering a product purchased by the first customer starts.

14. An information processing method, which is executed by a computer, the method including:
an acquisition step of acquiring an image, which is generated by a first camera, of a face;
an identification step of identifying a first customer who pays, based on the acquired image and database information in which a feature value of a face is registered; and
a notification step of notifying information for identifying the identified customer corresponding to the customer to a checkout apparatus,
in which, in the identification step, the first customer is identified before an operation of starting the settlement process is performed.

15. A program causing a computer to function as:
an acquisition unit that acquires an image, which is generated by a first camera, of a face;
an identification unit that identifies a first customer who pays, based on the acquired image and database information in which a feature value of a face is registered; and
a notification unit that notifies information for identifying the identified customer corresponding to the customer to a checkout apparatus,
in which the identification unit identifies the first customer before an operation of starting the settlement process is performed.

Hereinabove, although the claimed present invention is described with reference to the example embodiments, the claimed present invention is not limited to the above example embodiments. It is possible to make various modifications which can be understood by those skilled in the art in a scope of the claimed present invention, to the configurations and details of the claimed present invention.

This application claims priority based on Japanese Patent Application No. 2016-246537 filed on Dec. 20, 2016, and the content of the application is incorporated herein by reference in its entirety.

1. An information processing system comprising:
at least one memory configured to store instructions; and
at least one processor configured to execute the instructions to:
acquire an image generated by a first camera;
identify a first customer who pays, based on the acquired image and database information in which a feature value of a face is registered, before an operation of starting a settlement process is performed; and
perform the settlement process with respect to the identified first customer.

2. The information processing system according to claim 1,
wherein the processor is further configured to execute the instructions to start to identify the first customer in a case where a process of registering a product purchased by the first customer starts.

3. The information processing system according to claim 1,
wherein the processor is further configured to execute the instructions to start to identify the first customer in a case where the operation of starting settlement process is performed with respect to a second customer on which the settlement process is performed previous to the first customer.

4. The information processing system according to claim 1,
wherein the processor is further configured to execute the instructions to display a screen used to select a settlement method in a case where it is not possible to identify the first customer.

5. The information processing system according to claim 1,
wherein the processor is further configured to execute the instructions to:
acquire a plurality of the images, which are imaged at different timings, from the first camera, and
perform the settlement process with respect to the first customer who is identified at a newest image at a point of time in which the operation of starting the settlement process with respect to the first customer is performed.

6. The information processing system according to claim 5,
wherein the processor is further configured to execute the instructions to perform the settlement process with respect to the first customer who is identified in an image which is acquired before the newest image in a case where it is not possible to identify the first customer in the newest image.

7. The information processing system according to claim 1,
wherein the processor is further configured to execute the instructions to:
acquire an image of a face from a second camera which is installed in a different location from the first camera;
generate a customer database for identifying a customer who is visiting a store based on the image which is acquired from the second camera, and the database information; and
identify the first customer based on information of the generated customer database.

8. An information processing system comprising:
at least one memory configured to store instructions; and
at least one processor configured to execute the instructions to:
acquire an image generated by a first camera;
identify a first customer who pays, based on the acquired image and database information in which a feature value of a face is registered, in a case where a process of registering a product purchased by the first customer starts; and
perform a settlement process with respect to the identified first customer.

9. A customer identification apparatus comprising:
at least one memory configured to store instructions; and
at least one processor configured to execute the instructions to:
acquire an image generated by a first camera;
identify a first customer who pays, based on the acquired image and database information in which a feature value of a face is registered, before an operation of starting a settlement process is performed; and
notify information for identifying the identified first customer corresponding to the customer to a checkout apparatus.

10-11. (canceled)

12. The information processing system according to claim 2,
wherein the processor is further configured to execute the instructions to:
acquire a plurality of the images, which are imaged at different timings, from the first camera, and
perform the settlement process with respect to the first customer who is identified at a newest image at a point of time in which the operation of starting the settlement process with respect to the first customer is performed.

13. The information processing system according to claim 3,
wherein the processor is further configured to execute the instructions to:
acquire a plurality of the images, which are imaged at different timings, from the first camera, and
perform the settlement process with respect to the first customer who is identified at a newest image at a point of time in which the operation of starting the settlement process with respect to the first customer is performed.

14. The information processing system according to claim 4,
wherein the processor is further configured to execute the instructions to:
acquire a plurality of the images, which are imaged at different timings, from the first camera, and
perform the settlement process with respect to the first customer who is identified at a newest image at a point of time in which the operation of starting the settlement process with respect to the first customer is performed.

15. The information processing system according to claim 2,
wherein the processor is further configured to execute the instructions to:
acquire an image of a face from a second camera which is installed in a different location from the first camera;
generate a customer database for identifying a customer who is visiting a store based on the image which is acquired from the second camera, and the database information; and
identify the first customer based on information of the generated customer database.

16. The information processing system according to claim 3,
wherein the processor is further configured to execute the instructions to:
acquire an image of a face from a second camera which is installed in a different location from the first camera;
generate a customer database for identifying a customer who is visiting a store based on the image which is acquired from the second camera, and the database information; and
identify the first customer based on information of the generated customer database.

17. The information processing system according to claim 4,
wherein the processor is further configured to execute the instructions to:
acquire an image of a face from a second camera which is installed in a different location from the first camera;
generate a customer database for identifying a customer who is visiting a store based on the image which is acquired from the second camera, and the database information; and
identify the first customer based on information of the generated customer database.

18. The information processing system according to claim 5,
wherein the processor is further configured to execute the instructions to:
acquire an image of a face from a second camera which is installed in a different location from the first camera;
generate a customer database for identifying a customer who is visiting a store based on the image which is acquired from the second camera, and the database information; and
identify the first customer based on information of the generated customer database.

19. The information processing system according to claim 6,
wherein the processor is further configured to execute the instructions to:
acquire an image of a face from a second camera which is installed in a different location from the first camera;
generate a customer database for identifying a customer who is visiting a store based on the image which is acquired from the second camera, and the database information; and
identify the first customer based on information of the generated customer database.
